(19) United States
(12) Patent Application Publication
(10) Pub. No.: US 2025/0192285 A1
(43) Pub. Date: Jun. 12, 2025

(54) RETENTION BARRIER ASSEMBLIES FOR USE WITHIN TRACTION BATTERY PACKS

(71) Applicant: FORD GLOBAL TECHNOLOGIES, LLC, Dearborn, MI (US)

(72) Inventors: Joseph Fricano, Canton, MI (US); Karen Siler, Commerce Township, MI (US); Douglas Christian Lipp, Ann Arbor, MI (US); Jason C. Marcath, Dearborn, MI (US)

(21) Appl. No.: 18/953,158

(22) Filed: Nov. 20, 2024

Related U.S. Application Data
(60) Provisional application No. 63/607,888, filed on Dec. 8, 2023.

(51) Int. Cl. H01M 10/658; B60L 50/64; H01M 10/0525; H01M 50/211; H01M 50/293

(52) U.S. Cl. CPC H01M 10/658; B60L 50/64; H01M 10/0525; H01M 50/211; H01M 50/293; H01M 2220/20

(57) ABSTRACT

Retention barrier assemblies are provided for traction battery packs. The retention barrier assemblies may be multi-layered and multi-functional sandwich structures that include foam, insulation, a backer plate, and adhesive. The retention barrier assemblies serve numerous functions including but not limited to retaining/holding down battery cells within a cell stack, shielding portions of an enclosure assembly from thermal energy created when one or more battery cells release battery vent gases and/or other effluents during a battery thermal event, and controlling the flow of battery vent byproducts in the event of such a battery thermal event as part of a vent management strategy.

### CROSS-REFERENCE TO RELATED APPLICATIONS

This disclosure claims the benefit of U.S. Provisional Application No. 63/607,888, which was filed on Dec. 8, 2023 and is incorporated herein by reference in its entirety.

### TECHNICAL FIELD

This disclosure relates generally to traction battery packs, and more particularly to retention barrier assemblies for use within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly, a battery cell stack positioned within the enclosure assembly, and a retention barrier assembly arranged between the enclosure assembly and the battery cell stack. The retention barrier assembly includes a foam portion, an insulation portion, and a backer plate.

In a further non-limiting embodiment of the foregoing traction battery pack, the retention barrier assembly includes a first adhesive layer between the foam portion and the insulation portion.

In a further non-limiting embodiment of either of the foregoing traction battery packs, the retention barrier assembly includes a second adhesive layer between the insulation portion and the backer plate.

In a further non-limiting embodiment of any of the foregoing traction battery packs, the insulation portion is a mica sheet.

In a further non-limiting embodiment of any of the foregoing traction battery packs, the backer plate is a plastic plate.

In a further non-limiting embodiment of any of the foregoing traction battery packs, the backer plate is made of a polyamide.

In a further non-limiting embodiment of any of the foregoing traction battery packs, the retention barrier assembly is arranged to extend between a first thermal barrier assembly and a second thermal barrier assembly of the battery cell stack.

In a further non-limiting embodiment of any of the foregoing traction battery packs, the retention barrier assembly is supported by a first shelf of the first thermal barrier assembly and a second shelf of the second thermal barrier assembly.

In a further non-limiting embodiment of any of the foregoing traction battery packs, the retention barrier assembly is arranged to extend between a first cross-member assembly and a second cross-member assembly of the battery cell stack.

In a further non-limiting embodiment of any of the foregoing traction battery packs, the retention barrier assembly is supported by a first shelf of the first cross-member assembly and a second shelf of the second cross-member assembly.

In a further non-limiting embodiment of any of the foregoing traction battery packs, a retention structure of the first cross-member assembly is received within a through hole of the retention barrier assembly to retain the retention barrier assembly to the first cross-member assembly.

A traction battery pack according to another exemplary aspect of the present disclosure includes, among other things, an enclosure assembly including an enclosure cover, a battery cell stack positioned within the enclosure assembly and including a cell packet arranged in a first direction between a first thermal barrier assembly and a second thermal barrier assembly, and a retention barrier assembly supported at a position between the enclosure cover and the cell packet by the first thermal barrier assembly and the second thermal barrier assembly.

In a further non-limiting embodiment of the foregoing traction battery pack, the cell packet is arranged in a second direction between a first cross-member assembly and a second cross-member assembly.

In a further non-limiting embodiment of either of the foregoing traction battery packs, the retention barrier assembly is supported at the position by the first cross-member assembly and the second cross-member assembly.

In a further non-limiting embodiment of any of the foregoing traction battery packs, the retention barrier assembly is supported by a first shelf of the first cross-member assembly and a second shelf of the second cross-member assembly.

In a further non-limiting embodiment of any of the foregoing traction battery packs, a retention structure of the first cross-member assembly or the second cross-member assembly is received within a through hole of the retention barrier assembly to retain the retention barrier assembly to the first cross-member assembly or the second cross-member assembly.

In a further non-limiting embodiment of any of the foregoing traction battery packs, each of the first thermal barrier assembly and the second thermal barrier assembly includes an upper interfacing structure configured to interface with the enclosure cover.

In a further non-limiting embodiment of any of the foregoing traction battery packs, the upper interfacing structure includes an upper plateau configured to receive an adhesive and a tab that projects in an outboard direction from the upper plateau.

In a further non-limiting embodiment of any of the foregoing traction battery packs, the tab provides a shelf that is configured to support a portion of an outer perimeter of the retention barrier assembly.

In a further non-limiting embodiment of any of the foregoing traction battery packs, the retention barrier assembly includes a foam portion, an insulation portion, a backer plate, a first adhesive layer between the foam portion and the insulation portion, and a second adhesive layer between the backer plate and the insulation portion.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional perspective view of select portions of a cell stack of a traction battery pack.

FIG. 4 is a partial exploded view of the cell stack of FIG. 3.

FIG. 5 is a top view of a cell stack of a traction battery pack.

FIG. 6 is a cross-sectional view through section 6-6 of FIG. 5.

### DETAILED DESCRIPTION

This disclosure details retention barrier assemblies for traction battery packs. The retention barrier assemblies may be multi-layered and multi-functional sandwich structures that include foam, insulation, a backer plate, and adhesive. The retention barrier assemblies serve numerous functions including but not limited to retaining/holding down battery cells within a cell stack, shielding portions of an enclosure assembly from thermal energy created when one or more battery cells release battery vent gases and/or other effluents during a battery thermal event, and controlling the flow of battery vent byproducts in the event of such a battery thermal event as part of a vent management strategy. These and other features are discussed in greater detail in the following paragraphs of this detailed description.

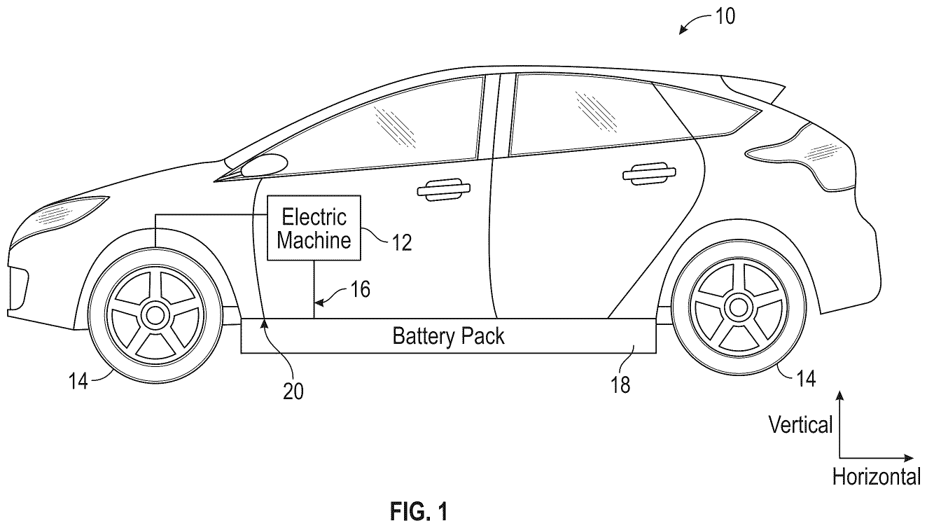

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

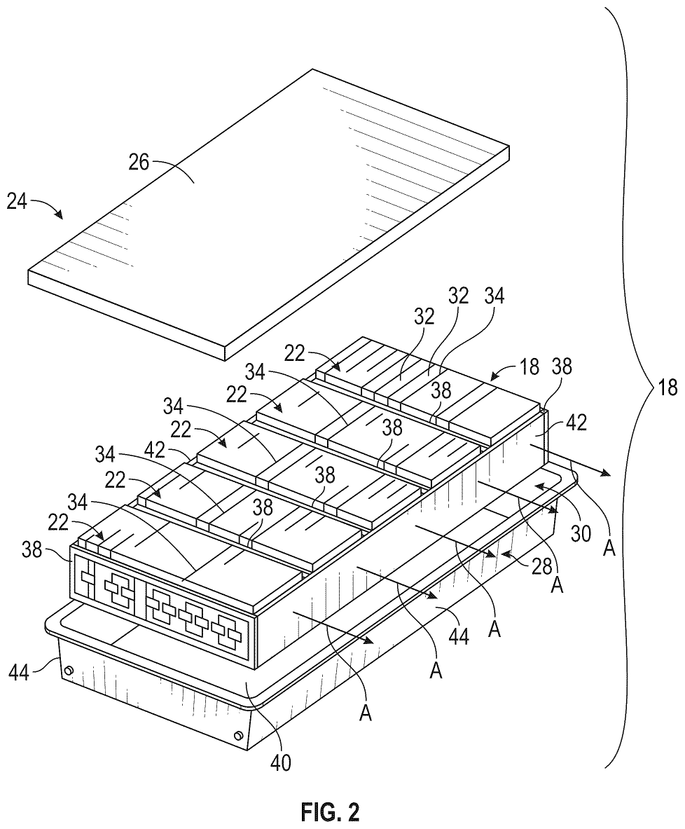

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together side-by-side of one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural plate members that span across a majority of the length of the longitudinally extending side wall 44 of the enclosure tray 28 and are thus sometimes referred to as structural “megabars” of the traction battery pack 18. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

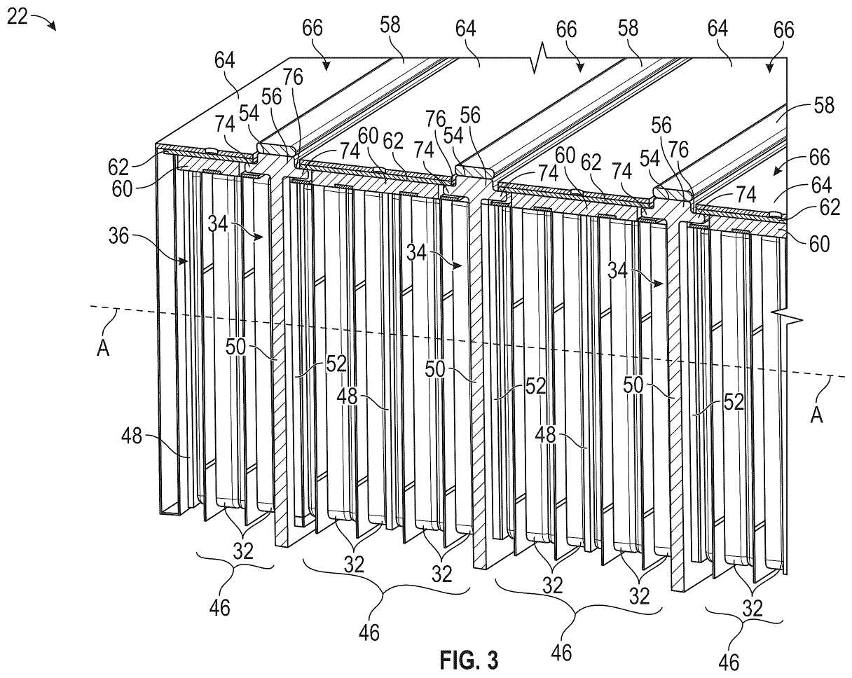

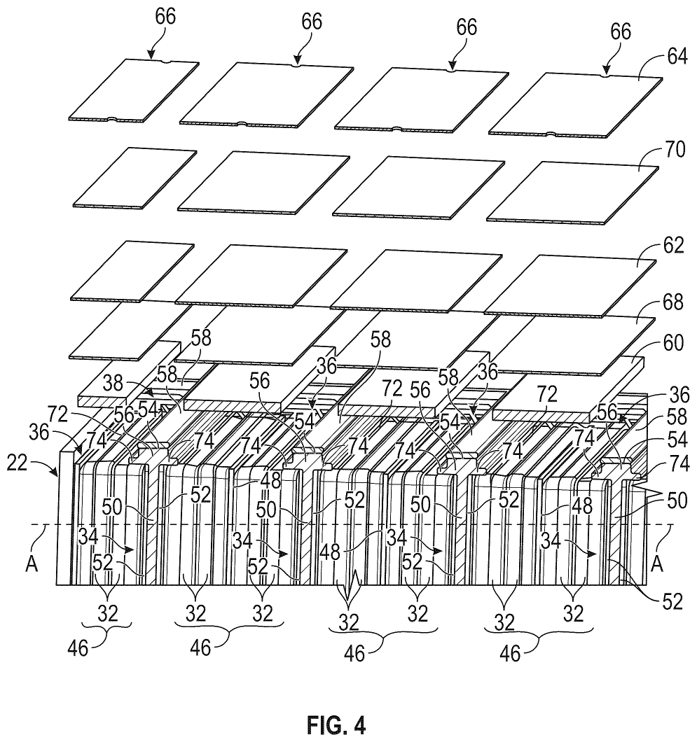

Referring now to FIGS. 3 and 4, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more groupings or compartments 36 of battery cells 32. Each compartment 36 may receive one or more of the battery cells 32 of the cell stack 22.

A cell packet 46 may be positioned within each compartment 36 of the cell stack 22. Each cell packet 46 may be separated from a neighboring cell packet 46 by one of the thermal barrier assemblies 34. Each cell packet 46 may include a plurality of battery cells 32 and a cell expansion pad 48 arranged between immediately neighboring battery cells 32 within the cell packet 46. The cell expansion pads 48 may include a material(s) adapted for accommodating battery cell swelling. The material may include polyurethane foam or silicone foam, for example. However, other materials or combinations of materials could be utilized to provide the cell expansion pads 48 with battery swelling accommodating properties within the scope of this disclosure.

Should, for example, a battery thermal event occur in one of the cell packets 46, the thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18. The thermal barrier assemblies 34 may further be configured to structurally join battery structures (e.g., the enclosure cover 26 and the enclosure tray 28) to increase the structural integrity of the traction battery pack 18.

Each thermal barrier assembly 34 of the cell stack 22 may include a structural barrier 50 that is flanked by pairs of thermal resistance material layers 52 as part of a multi-layered structure of the thermal barrier assembly 34. The structural barrier 50 may be sandwiched between the thermal resistance material layers 52. The thermal resistance material layers 52 can be positioned in abutting contact with major side surfaces of battery cells 32 located in adjacent compartments 36 of the cell stack 22.

The structural barriers 50 may each include a thermoplastic structure or a polymer composite structure (e.g., glass fiber reinforced polypropylene with an intumescent additive), for example, and the thermal resistance material layers 52 may include aerogel layers or mica sheets, for example. However, other materials or combinations of materials could be utilized to construct the subcomponents of the thermal barrier assembly 34 within the scope of this disclosure.

The structural barrier 50 of each thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The structural barrier 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 50. In other implementations, the structural barrier 50 could be an injection molded part or an extruded part.

The structural barrier 50 of each thermal barrier assembly 34 may include an upper interfacing structure 56 that is configured to interface with the enclosure cover 26 or an intermediate structure (e.g., a heat exchanger plate) that is positioned between the thermal barrier assembly 34 and the enclosure cover 26. The upper interfacing structure 56 may include an upper plateau 54 for receiving an adhesive 58. The adhesive 58 may be utilized to secure each thermal barrier assembly 34 to the enclosure cover 26. The adhesive 58 may be an epoxy based adhesive or a urethane based adhesive, for example. Once the upper interfacing structures 56 are secured relative to the enclosure cover 26, the thermal barrier assemblies 34 can substantially prevent thermal energy from moving from one compartment 36 to another at the sealed interfaces between the thermal barrier assemblies 34 and the enclosure cover 26, such as during a battery thermal event, for example.

An additional amount of the adhesive 58 (see FIG. 4) may be utilized to secure the cross-member assemblies 38 of the cell stack 22 to the enclosure cover 26. Once the adhesive 58 cures, the cell stack 22 and the enclosure cover 26 are effectively structurally coupled to one another, thereby increasing the structural stiffness of the traction battery pack 18.

One or more retention barrier assemblies 66 may be arranged axially (e.g., vertically) between the cell stack 22 and the enclosure cover 26. The retention barrier assemblies 66 may serve multiple functions. For example, each retention barrier assembly 66 may be configured to retain/hold down the battery cells 32 in the vertical or Z-axis direction of the cell stack 22, shield the enclosure cover 26 from thermal energy created when one or more battery cells 32 of one or more of the cell packets 46 release battery vent gases and/or other effluents during a battery thermal event, and control the flow of battery vent byproducts in the event of such a battery thermal event as part of a vent management strategy.

Each retention barrier assembly 66 may include a multi-layered sandwich structure that can be installed over top of the battery cells 32 of one of the cell packets 46 of the cell stack 22. Each retention barrier assembly 66 may include a foam portion 60, an insulation portion 62, a backer plate 64, a first adhesive layer 68, and a second adhesive layer 70. The first adhesive layer 68 may secure the foam portion 60 to the insulation portion 62 and the second adhesive layer 70 may secure the backer plate 64 to the insulation portion 62 for constructing the multi-layered sandwich structure.

The foam portion 60 of each retention barrier assembly 66 may be configured as a foam block, for example. The foam portion 60 is compressible and can thus function to apply a retention force against the battery cells 32 for Z-axis retention. The foam portion 60 may be further configured to fold seams 72 (see FIG. 4) of the battery cells 32 for retaining the seams 72 on the tops of the battery cells 32, thereby increasing battery cell life.

The insulation portion 62 of each retention barrier assembly 66 may be configured as a mica sheet that is capable of limiting or even preventing battery vent gases and/or effluents from influencing the structural integrity of the enclosure cover 26. However, other flame resistant and heat insulating materials could be utilized to construct the insulation portion 62 within the scope of this disclosure.

The backer plate 64 of each retention barrier assembly 66 may be configured as a plastic plate for providing structural integrity to the retention barrier assembly 66. The backer plate 64 may be made of a polyamide, such as nylon 66, for example. However, other materials are contemplated within the scope of this disclosure.

Each retention barrier assembly 66 may be supported within the cell stack 22 by the upper interfacing structures 56 of the structural barriers 50 of adjacent thermal barrier assemblies 34. For example, each upper interfacing structure 56 may include tabs 74 that project in an outboard direction relative to the upper plateau 54 of the upper interfacing structure 56. Each tab 74 may establish a shelf 76 for supporting a portion of an outer perimeter of the retention barrier assembly 66. Each retention barrier assembly 66 may therefore extend from the tab 74 of one structural barrier 50 to the tab 74 of another structural barrier 50 at a position that is directly over top of one of the cell packets 46 of the cell stack 22.

Each shelf 76 may extend within a plane that is vertically lower than the upper plateau 54 of each upper interfacing structure 56. Thus, when the retention barrier assembly 66 is arranged over the cell stack 22, the backer plate 64 is positioned vertically lower than the adhesive 58, thereby maintaining a consistent height at which the adhesive 58 can interface with the enclosure cover 26 during assembly of the traction battery pack 18.

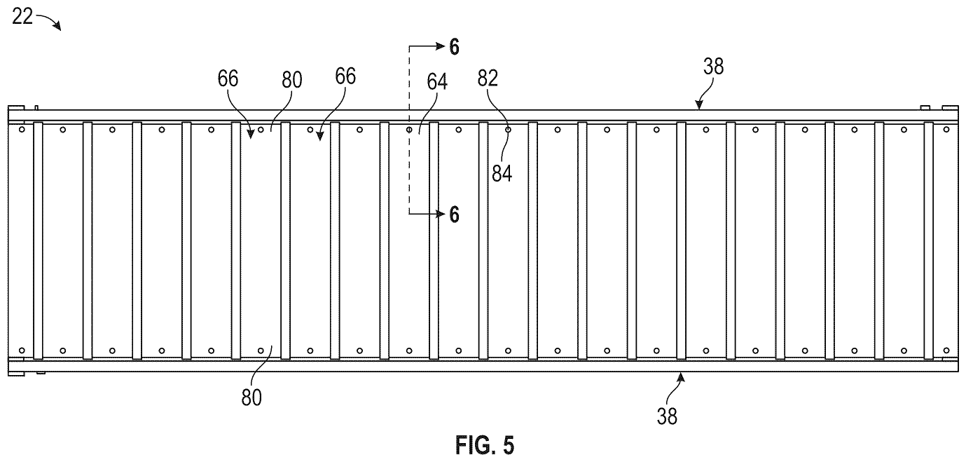

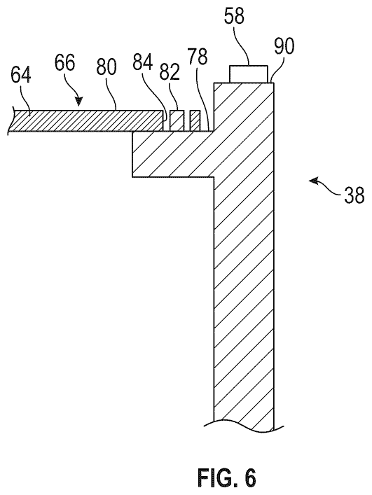

Each retention barrier assembly 66 may additionally be supported relative to the cell stack 22 by the cross-member assemblies 38. For example, as best shown in FIGS. 5-6, opposing longitudinal ends 80 of each retention barrier assembly 66 may be supported by the cross-member assemblies 38.

Each cross-member assembly 38 may include a shelf 78 (see FIG. 6) for supporting the retention barrier assembly 66 at one of its longitudinal ends 80. Each shelf 78 may extend within a plane that is vertically lower than an upper surface 90 of the cross-member assembly 38 upon which the adhesive 58 is applied. Thus, when the retention barrier assembly 66 is arranged over the cell stack 22, the backer plate 64 is positioned vertically lower than the adhesive 58, thereby maintaining a consistent height at which the adhesive 58 can interface with the enclosure cover 26 during assembly.

In an embodiment, each retention barrier assembly 66 may be retained in place over its respective cell packet 46 by one or more retention structures 82. In an embodiment, the retention structures 82 protrude outwardly from the shelves 78 of the cross-member assemblies 38 and can be accommodated within through holes 84 of the retention barrier assemblies 66. In an embodiment, the through holes 84 are formed in the backer plate 64 of each retention barrier assembly 66.

In an embodiment, the retention structures 82 are heat stakes. However, other configurations, including but not limited to fasteners, welds, clips, etc., could be utilized to retain the retention barrier assemblies 66 to the cell stack 22.

The retention barrier assemblies of this disclosure may be arranged to establish an intermediate barrier between the cell packets of a cell stack and an enclosure cover in order to protect the cover from gases/effluents and their associated heat without compromising adhesive retention and sealing. The exemplary retention barrier assemblies may be provided in individual sections for providing a scalable solution for battery cell retention and cell vent management as part of a more simplified traction battery assembly process.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly;
a battery cell stack positioned within the enclosure assembly; and
a retention barrier assembly arranged between the enclosure assembly and the battery cell stack and including a foam portion, an insulation portion, and a backer plate.

2. The traction battery pack as recited in claim 1, wherein the retention barrier assembly includes a first adhesive layer between the foam portion and the insulation portion.

3. The traction battery pack as recited in claim 2, wherein the retention barrier assembly includes a second adhesive layer between the insulation portion and the backer plate.

4. The traction battery pack as recited in claim 1, wherein the insulation portion is a mica sheet.

5. The traction battery pack as recited in claim 1, wherein the backer plate is a plastic plate.

6. The traction battery pack as recited in claim 5, wherein the backer plate is comprised of a polyamide.

7. The traction battery pack as recited in claim 1, wherein the retention barrier assembly is arranged to extend between a first thermal barrier assembly and a second thermal barrier assembly of the battery cell stack.

8. The traction battery pack as recited in claim 7, wherein the retention barrier assembly is supported by a first shelf of the first thermal barrier assembly and a second shelf of the second thermal barrier assembly.

9. The traction battery pack as recited in claim 1, wherein the retention barrier assembly is arranged to extend between a first cross-member assembly and a second cross-member assembly of the battery cell stack.

10. The traction battery pack as recited in claim 9, wherein the retention barrier assembly is supported by a first shelf of the first cross-member assembly and a second shelf of the second cross-member assembly.

11. The traction battery pack as recited in claim 9, wherein a retention structure of the first cross-member assembly is received within a through hole of the retention barrier assembly to retain the retention barrier assembly to the first cross-member assembly.

12. A traction battery pack, comprising:
an enclosure assembly including an enclosure cover;
a battery cell stack positioned within the enclosure assembly and including a cell packet arranged in a first direction between a first thermal barrier assembly and a second thermal barrier assembly; and
a retention barrier assembly supported at a position between the enclosure cover and the cell packet by the first thermal barrier assembly and the second thermal barrier assembly.

13. The traction battery pack as recited in claim 12, wherein the cell packet is arranged in a second direction between a first cross-member assembly and a second cross-member assembly.

14. The traction battery pack as recited in claim 13, wherein the retention barrier assembly is supported at the position by the first cross-member assembly and the second cross-member assembly.

15. The traction battery pack as recited in claim 14, wherein the retention barrier assembly is supported by a first shelf of the first cross-member assembly and a second shelf of the second cross-member assembly.

16. The traction battery pack as recited in claim 15, wherein a retention structure of the first cross-member assembly or the second cross-member assembly is received within a through hole of the retention barrier assembly to retain the retention barrier assembly to the first cross-member assembly or the second cross-member assembly.

17. The traction battery pack as recited in claim 12, wherein each of the first thermal barrier assembly and the second thermal barrier assembly includes an upper interfacing structure configured to interface with the enclosure cover.

18. The traction battery pack as recited in claim 17, wherein the upper interfacing structure includes an upper plateau configured to receive an adhesive and a tab that projects in an outboard direction from the upper plateau.

19. The traction battery pack as recited in claim 18, wherein the tab provides a shelf that is configured to support a portion of an outer perimeter of the retention barrier assembly.

20. The traction battery pack as recited in claim 12, wherein the retention barrier assembly includes a foam portion, an insulation portion, a backer plate, a first adhesive layer between the foam portion and the insulation portion, and a second adhesive layer between the backer plate and the insulation portion.
